(19) United States
(12) Patent Application Publication
(10) Pub. No.: US 2017/0346557 A1
(43) Pub. Date: Nov. 30, 2017

(54) UNDERWATER VISIBLE LIGHT TRANSCEIVING TERMINAL

(71) Applicant: Korea Maritime and Ocean University Research and Development Business Foundation, Busan (KR)

(72) Inventors: Hyung Sik CHOI, Busan (KR); Hyun Joong SON, Busan (KR); Hyeon Seung KANG, Busan (KR)

(21) Appl. No.: 15/164,141

(22) Filed: May 25, 2016

(51) Int. Cl. H04B 10/116; G01S 19/13; H04B 10/40; H04B 10/80

(52) U.S. Cl. CPC H04B 10/116; H04B 10/80; G01S 19/13; H04B 10/40

(57) ABSTRACT

Disclosed herein is an underwater visible light transceiving terminal, which is capable of easily receiving a visible-light signal transmitted from a certain direction, through an optical-fiber assembly composed of a plurality of optical fibers that are radially arranged, and which is capable of delivering data, sent from a main communication station, in several directions in the form of a visible-light signal in the water through the optical-fiber assembly, thus allowing a submarine or a submergence robot to effectively receive the visible-light signal.

### BACKGROUND OF THE INVENTION

### 1. Field of the Invention

The present invention relates generally to an underwater visible light transceiving terminal. More particularly, the present invention relates to an underwater visible light transceiving terminal, which is capable of easily receiving a visible-light signal transmitted from a certain direction, through an optical-fiber assembly composed of a plurality of optical fibers that are radially arranged, and which is capable of simultaneously delivering data, received from outside (main communication station), in several directions in the form of a visible-light signal through the optical-fiber assembly, thus allowing a submarine or a submergence robot located therearound to effectively receive the visible-light signal.

### 2. Description of the Related Art

As people are growing increasingly interested in the sea due to it being a rich repository of resources, an exploration submarine, an underwater robot, and the like for conducting aquatic research are being widely developed and used.

An underwater moving body such as an exploration submarine and an underwater robot is likely to be continuously and widely used. In addition, it is expected that moving bodies having various shapes and functions will be developed.

When exploration or work is performed in the water, communication should be made between the underwater moving bodies, and thus technology of underwater wireless communication is essential.

The technology of underwater wireless communication adopts various methods. An underwater wireless communication method that is most generally used employs sound waves. However, since the method employing sound waves is limited in communication speed due to the characteristics of sound waves, it is impossible to transmit high-capacity data in a short time.

Recently, there is growing demand for the underwater wireless communication technology that is capable of transmitting high-capacity data, for example, underwater image data. Research into the related technology is actively being conducted.

In order to overcome the limitations of the underwater wireless communication technology using the sound waves, in recent years, visible-light communication using an LED or laser has arisen as an appealing option.

Visible-light communication is a technology for transmitting data using a visible-light signal, and is characterized in that it is possible to rapidly transmit high-capacity data because of a wide bandwidth and a high communication speed.

However, in contrast to radio waves or sound waves that are transmitted beyond an obstacle due to diffraction characteristics, a visible-light signal is transmitted only rectilinearly. Hence, a transmitting direction thereof should be necessarily identical with a receiving direction thereof.

Therefore, in order to allow visible-light communication technology to be employed in the water, a transceiving direction of an underwater moving body that continuously moves in the water should be necessarily identical with that of an underwater visible light transceiving terminal installed in any place in the water.

However, it is very difficult for the underwater moving body moving in any direction to transmit a visible-light signal in an accurate direction towards an underwater visible light transceiving terminal. Further, it is very difficult for an underwater visible light transceiving terminal to accurately receive a visible-light signal from any direction.

Likewise, it is very difficult to transmit a visible-light signal in an accurate direction towards an underwater moving body that is moving in any direction. Further, it is very difficult for an underwater moving body that is moving to accurately receive the visible-light signal that is transmitted in a specific direction.

Therefore, there is an urgent need for the development of a novel underwater visible light transceiving terminal, which can smoothly receive a visible-light signal from any direction and can smoothly transmit a visible-light signal to an underwater moving body that is continuously moving in any direction.

### SUMMARY OF THE INVENTION

Accordingly, the present invention has been made keeping in mind the above problems occurring in the related art, and the present invention is intended to propose an underwater visible light transceiving terminal, which is capable of easily receiving a visible-light signal transmitted from a certain direction, through an optical-fiber assembly composed of a plurality of optical fibers that are radially arranged, and which is capable of simultaneously delivering data, received from the outside (main communication station), in several directions in the form of a visible-light signal through the optical-fiber assembly, thus allowing an underwater moving body located therearound to smoothly receive a visible-light signal.

In order to accomplish the above object, the present invention provides an underwater visible light transceiving terminal, including a main-body case including a frame for holding optical fibers; an optical-fiber assembly composed of a plurality of optical fibers, first ends of the optical fibers being fixedly coupled to the frame for holding the optical fibers and being disposed to face an inside of the main-body case, second ends of the optical fibers being radially arranged to face an outside of the main-body case, the optical-fiber assembly causing a visible-light signal transmitted from any direction to be easily received through the second ends of the optical fibers, and causing the visible-light signal to be delivered in various directions through the second ends of the optical fibers; a visible-light receiver provided in the main-body case to receive the visible-light signal from a first end of the optical-fiber assembly and then convert the visible-light signal into an electric signal; a visible-light transmitter provided in the main-body case to convert the electric signal into the visible-light signal and then transmit the visible-light signal to the first end of the optical-fiber assembly; a first control unit performing control to send the electric signal converted by the visible-light receiver to an outside and to convert the electric signal, sent from the outside, into the visible-light signal by the visible-light transmitter; a power unit supplying actuating power to the visible-light receiver, the visible-light transmitter, and the first control unit; and a weight unit coupled to a lower portion of the main-body case to cause the main-body case to rest on a seabed.

The underwater visible light transceiving terminal may further include a condensing lens between the visible-light receiver and the frame for holding the optical fibers, the visible-light transmitter being arranged to surround the visible-light receiver.

The underwater visible light transceiving terminal may further include a buoyant material connected to the main-body case; and a releasing unit positioned between the main-body case and the weight unit to release connection between the main-body case and the weight unit. If the power of the power unit becomes equal to or less than a reference value, the first control unit may actuate the releasing unit to separate the weight unit from the main-body case, and, if the weight unit is separated from the main-body case, the main-body case may float to a surface of water by buoyancy of the buoyant material.

The buoyant material may be provided with a GPS receiver to detect a location, and a location data transmitter to send location data, detected by and input from the GPS receiver, to the outside.

The above-mentioned underwater visible light transceiving terminal of the present invention is advantageous in that it is capable of easily receiving a visible-light signal transmitted from a certain direction, through an optical-fiber assembly composed of a plurality of optical fibers that are radially arranged, and is capable of simultaneously delivering data, received from the outside (main communication station), in several directions in the form of a visible-light signal through the optical-fiber assembly, thus allowing an underwater moving body such as a submarine or a submergence robot to smoothly receive a visible-light signal.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a perspective view illustrating an underwater visible light transceiving terminal according to an embodiment of the present invention;

FIG. 2 is a partial sectional view illustrating the underwater visible light transceiving terminal of FIG. 1;

FIG. 3 is an exploded perspective view illustrating the structure of main components in the main-body case of FIG. 1;

FIGS. 4 to 6 are views illustrating an operation of the underwater visible light transceiving terminal of FIG. 1; and

FIG. 7 is a conceptual view illustrating a data transceiving system using the underwater visible light transceiving terminal of FIG. 1.

### DESCRIPTION OF PREFERRED EMBODIMENTS

Hereinafter, an underwater visible light transceiving terminal according to a preferred embodiment of the present invention will be described in detail with reference to the accompanying drawings. When it is determined that the detailed description of the related art may obscure the gist of the present invention, the detailed description thereof will be omitted herein.

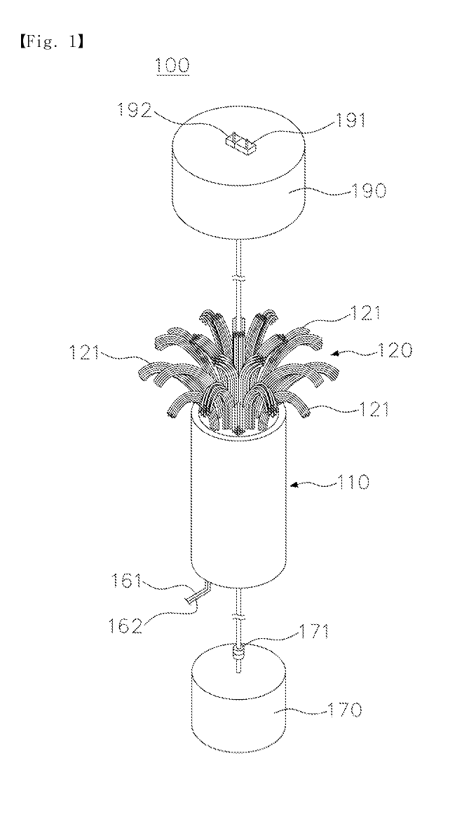

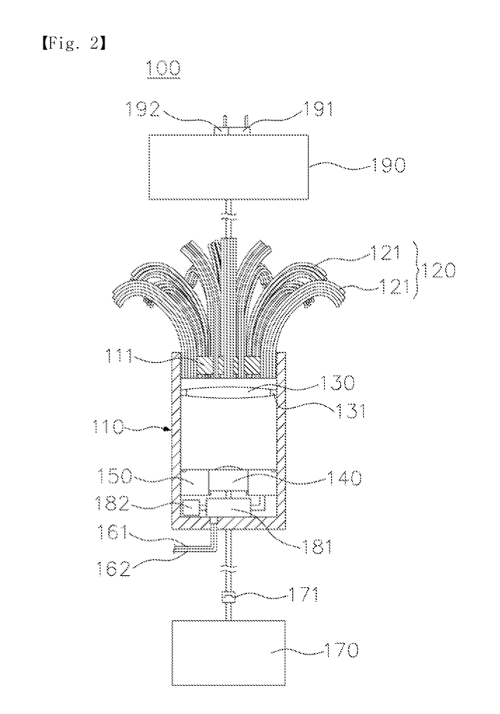

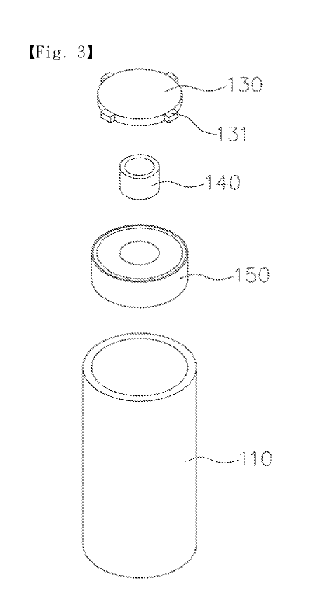

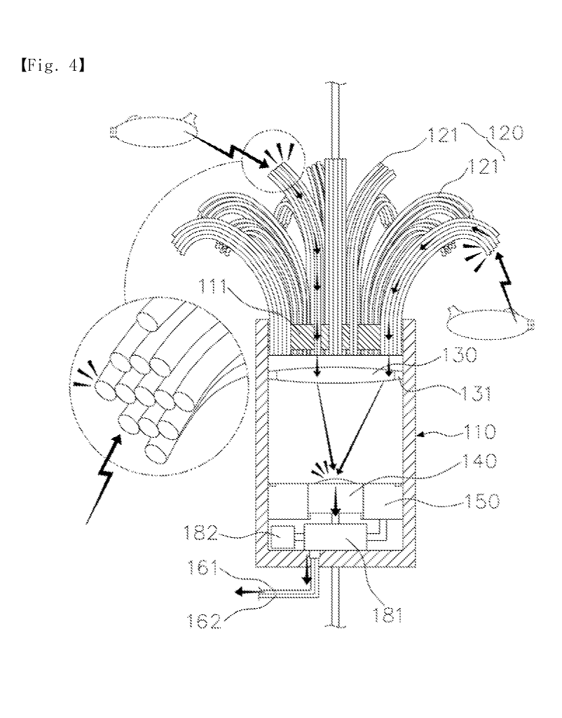

FIG. 1 is a perspective view illustrating an underwater visible light transceiving terminal according to an embodiment of the present invention, FIG. 2 is a partial sectional view illustrating the underwater visible light transceiving terminal of FIG. 1, FIG. 3 is a perspective view illustrating the structure of main components in the main-body case of FIG. 1, and FIGS. 4 to 6 are views illustrating an operation of the underwater visible light transceiving terminal of FIG. 1.

The underwater visible light transceiving terminal 100 according to the present invention includes a main-body case 110, an optical-fiber assembly 120, a condensing lens 130, a visible-light receiver 140, a visible-light transmitter 150, a weight unit 170, a first control unit 181, a power unit 182, and a buoyant material 190.

Various devices are accommodated in the main-body case 110, with a frame 111 for holding optical fibers being provided on an upper portion of the main-body case 110.

One end of the optical-fiber assembly 120 composed of a plurality of optical fibers 121 is coupled to a frame 111 for holding optical fibers.

The optical-fiber assembly 120 is provided to receive a visible-light signal in the water and then transmit the visible-light signal to the visible-light receiver 140, or to deliver the visible-light signal transmitted from the visible-light transmitter 150 to the water. First ends of the optical fibers 121 are fixedly coupled to the frame 111 for holding optical fibers and are disposed to face an inside of the main-body case 110, while second ends of the optical fibers 121 exposed to an outside are radially disposed towards the outside of a main-body case 110.

Since the ends of the optical fibers 121 constituting the optical-fiber assembly 120 are radially spread to face in different directions, it is possible to effectively receive the visible-light signal entering from a certain direction, and simultaneously deliver the visible-light signal in several directions.

That is, as illustrated in FIG. 4, if a submarine or an underwater robot that is continuously moving for the purpose of underwater exploration delivers the visible-light signal, in a direction where the underwater visible light transceiving terminal 100 is located, so as to transceive data, the optical fibers 121 spread radially allow the visible-light signal to be effectively received regardless of a location of the submarine or the underwater robot.

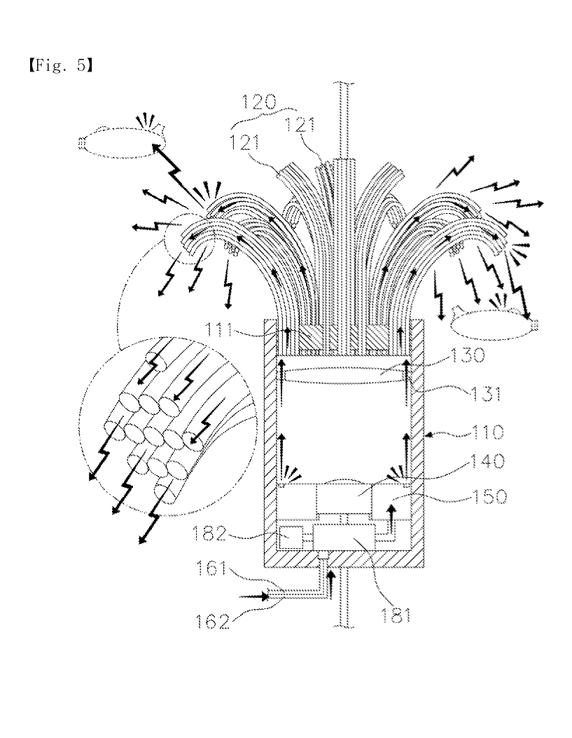

As illustrated in FIG. 5, if the visible-light signal is delivered in the water through the optical-fiber assembly 120 so as to transmit data to the submarine or the underwater robot that is exploring in the water, signals are delivered in various directions completely covering the surroundings by the radially spread optical fibers 121 of the optical-fiber assembly 120. Therefore, the submarine or the underwater robot is able to effectively receive the visible-light signal regardless of a location.

The condensing lens 130 is located under the frame 111 for holding optical fibers. The condensing lens 130 concentrates the visible-light signal received through the optical-fiber assembly 120, and then transmits the visible-light signal to the visible-light receiver 140.

That is, as illustrated in FIG. 4, if any one of the optical fibers 121 constituting the optical-fiber assembly 120 receives the visible-light signal, the condensing lens concentrates the visible-light signal, and then transmits the visible-light signal to the visible-light receiver 140.

As illustrated in FIG. 3, the condensing lens 130 is located in the center of the main-body case 110 to be spaced apart from an inner circumference thereof. A spacer 131 is provided on an edge of the condensing lens 130 to cause the condensing lens 130 to be spaced apart from the inner circumference of the main-body case 110.

The visible-light receiver 140 and the visible-light transmitter 150 are provided under the condensing lens 130.

The visible-light receiver 140 receives the visible-light signal, which was received by the optical-fiber assembly 120 via the condensing lens 130, and then converts the visible-light signal into an electric signal to transmit it to the outside (main communication station).

The visible-light transmitter 150 is configured to convert the electric signal, received from the outside (main communication station), into the visible-light signal and thereby deliver the signal in the water through the optical-fiber assembly 120.

As illustrated in FIG. 5, the visible-light signal transmitted to the visible-light receiver 150 passes through the condensing lens 130, but the visible-light signal outputted from the visible-light transmitter 150 is directly transmitted to the optical fibers 121 of the optical-fiber assembly 120 without passing through the condensing lens 130.

To this end, the aforementioned spacer 131 is provided on the edge of the condensing lens 130, and the visible-light transmitter 150 is arranged to surround the visible-light receiver 140.

That is, the visible-light receiver 140 is disposed in the center of the main-body case 110, and the visible-light transmitter 150 is disposed along an inner edge of the main-body case 110.

The first control unit 181 controls to convert the visible-light signal received by the visible-light receiver into the electric signal and thereby transmit the electric signal to the outside (main communication station). In addition, the first control unit 181 also serves to perform control such that the visible-light transmitter 150 converts the electric signal transmitted from the outside (main communication station) into the visible-light signal and then sends the visible-light signal.

The first control unit 181 is also connected with a data output unit 161 and a data input unit 162.

The data output unit 161 transmits data, converted into the electric signal by the visible-light receiver 140, into the outside (main communication station). The data output unit 161 transmits data through wireless communication or wire communication.

The data input unit 162 receives data from the outside (main communication station) and then transmits it to the visible-light transmitter 150. The data input unit 162 transmits data through wireless communication or wire communication.

The power unit 182 supplies actuating power to the visible-light receiver 140, the visible-light transmitter 150, and the first control unit 181.

The weight unit 170 is coupled to the lower portion of the outside of the main-body case 110, and causes the main-body case 110 to sink to rest on a seabed by the weight of the weight unit 170 itself. Preferably, the weight unit 170 causes the main-body case 110 to be fixed to the seabed. Of course, the weight unit 170 causes various devices coupled to the main-body case 110 to be fixed to the seabed.

A process of transmitting data in the form of the electric signal or the visible-light signal through the underwater visible light transceiving terminal 100 is as follows.

As illustrated in FIG. 4, if the visible-light signal transmitted in the water through one or many of the optical fibers 121 constituting the optical-fiber assembly 120 is received, the visible-light signal is moved through the optical fibers 121 to the condensing lens 130. The moved visible-light signal is concentrated while passing through the condensing lens 130, and then is transmitted to the visible-light receiver 140. Further, the visible-light signal transmitted to the visible-light receiver 140 is converted into the electric signal, and then is transmitted through the data output unit 161 to the outside (main communication station).

As illustrated in FIG. 5, if the electric signal is transmitted from the outside (main communication station) to the data input unit 162, the visible-light transmitter 150 converts the electric signal into the visible-light signal, and then transmits the visible-light signal to the optical-fiber assembly 120. The visible-light signal transmitted to the optical-fiber assembly 120 is delivered in various directions in the water through the plurality of optical fibers 121 that are radially arranged.

Thus, the underwater visible light transceiving terminal is capable of effectively receiving the visible-light signal transmitted from a certain direction, through the optical-fiber assembly 120 that is composed of the plurality of radially arranged optical fibers 121. Further, the underwater visible light transceiving terminal 100 delivers the visible-light signal in various directions in the water, thus enabling the visible-light signal to be effectively transmitted to a submarine or an underwater robot around the underwater visible light transceiving terminal 100 that is moving for the purpose of underwater exploration.

Meanwhile, as illustrated in FIGS. 1 and 2, the buoyant material 190 having predetermined buoyancy is connected to the main-body case 110. In addition, a releasing unit 171 is provided between the main-body case 110 and the weight unit to release the connection between the main-body case 110 and the weight unit 170.

If the power of the power unit 182 becomes equal to or less than a reference value, the first control unit 181 operates the releasing unit 171 to separate the weight unit from the main-body case 110. If the weight unit 170 is separated from the main-body case 110, the main-body case 110 and the devices provided therein float to the surface of the water by the buoyancy of the buoyant material 190. Of course, when the main-body case 110 floats to the surface of the water, the weight unit 170 remains on the seabed.

A burn-out cutting device may be proposed as an example of the releasing unit 171 of the present embodiment. The releasing unit 171 may be implemented in various forms.

That is, if the power of the power unit 182 falls below a predetermined level, the releasing unit 171 is operated to disconnect the weight unit 170 from the main-body case 110. Further, the underwater visible light transceiving terminal 100, except for the weight unit 170, floats to the surface of the water through the buoyancy of the buoyant material 190, so that it is possible to recover the underwater visible light transceiving terminal 100. After the underwater visible light transceiving terminal 100 is recovered, the discharged power unit 182 may be charged or replaced with a new one to be reused.

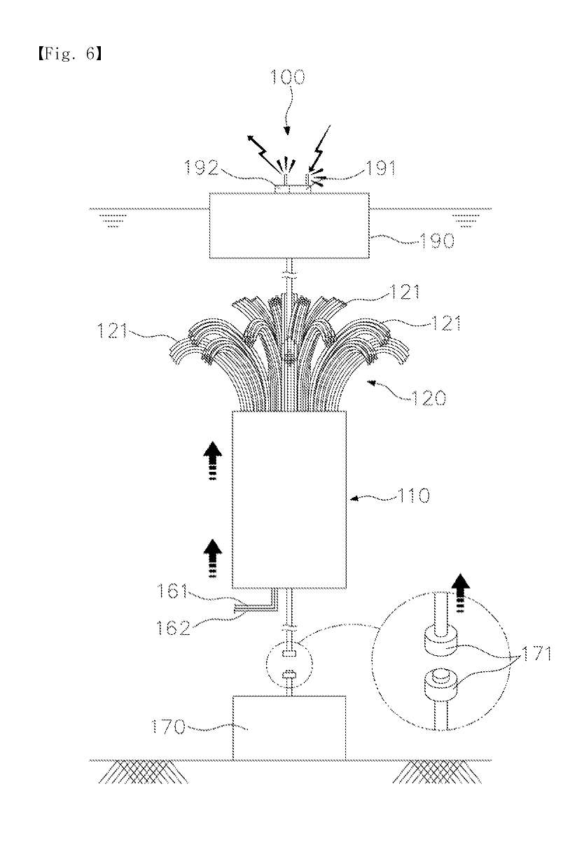

As illustrated in FIG. 6, in order to detect location data and transmit it to the outside if the buoyant material floats to the surface of the water, a GPS receiver 191 and a location data transmitter 192 are provided on the buoyant material 190. The GPS receiver 191 detects location data. The location data transmitter 192 sends the location data, input from the GPS receiver 191, to the outside.

That is, if the underwater visible light transceiving terminal 100 floats to the surface of the water together with the buoyant material 190, the GPS receiver 191 detects current location data and delivers the location data through the location data transmitter 192 to the outside. Thus, it is possible to easily recover the underwater visible light transceiving terminal 100.

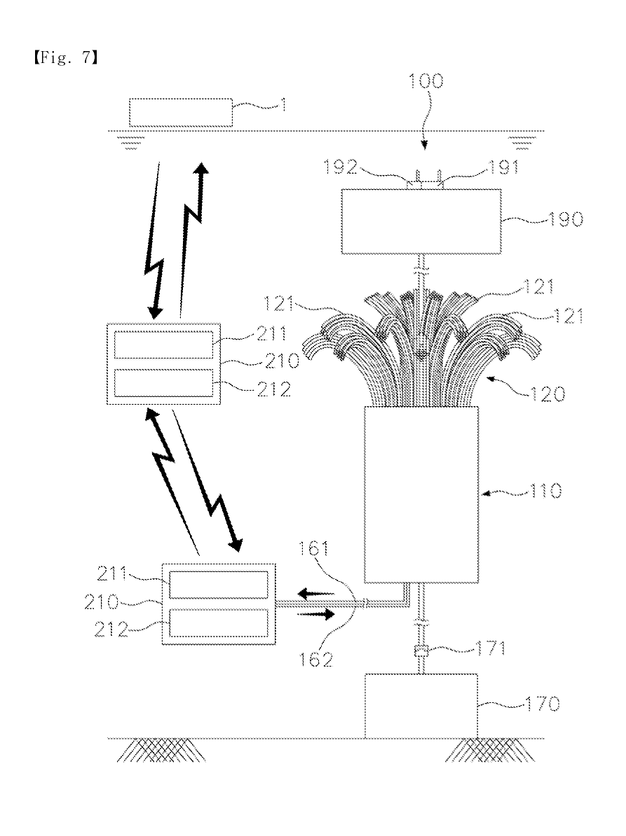

A data transceiving system using the underwater visible light transceiving terminal 100 will be described with reference to FIG. 7.

FIG. 7 is a conceptual view illustrating the data transceiving system using the underwater visible light transceiving terminal of FIG. 1.

At least one gate 210 through which the main communication station 1 communicates with the underwater visible light transceiving terminal 100 is provided.

The gate 210 receives data, sent from the data output unit 161 of the underwater visible light transceiving terminal 100, and then sends the data to the main communication station 1. Further, the gate 210 receives data, sent from the main communication station 1, and then sends the data to the data input unit 162 of the underwater visible light transceiving terminal 100.

The gate 210 includes a database 211 to store data transmitted from the underwater visible light transceiving terminal 100 and the main communication station 1, and a second control unit 212 that performs control to transmit the data stored in the database 211 to the underwater visible light transceiving terminal 100 and the main communication station 1.

Data is transceived through wireless communication or wire communication between the gate 210 and the underwater visible light transceiving terminal 100 and between the gate and the main communication station 1. To this end, the gate 210 is provided with transmission equipment (not shown) to transceive data.

As illustrated in FIG. 7, the data transceiving system may be equipped with two or more gates 210 and operated. The gate 210 adjacent to the underwater visible light transceiving terminal 100 transceives data with the underwater visible light transceiving terminal 100 through the wire communication, while the gate 210 adjacent to the main communication station 1 transceives data with the main communication station 1 through the wireless communication. In addition, the respective gates 210 construct a system to transceive data therebetween through the wire communication or the wireless communication, thus allowing data to be smoothly exchanged even if the underwater visible light transceiving terminal 100 is far away from the main communication station 1.

As described above, the present invention provides an underwater visible light transceiving terminal, which is capable of easily receiving a visible-light signal transmitted from a certain direction, through an optical-fiber assembly composed of a plurality of optical fibers that are radially arranged, and which is capable of simultaneously delivering data, received from the outside (main communication station), in several directions in the form of a visible-light signal through the optical-fiber assembly, thus allowing an underwater moving body such as a submarine or a submergence robot to smoothly receive a visible-light signal.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An underwater visible light transceiving terminal, comprising:
a main-body case including a frame for holding optical fibers;
an optical-fiber assembly composed of a plurality of optical fibers, first ends of the optical fibers being fixedly coupled to the frame for holding the optical fibers and being disposed to face an inside of the main-body case, second ends of the optical fibers being radially arranged to face an outside of the main-body case, the optical-fiber assembly causing a visible-light signal transmitted from any direction to be easily received through the second ends of the optical fibers, and causing the visible-light signal to be delivered in various directions through the second ends of the optical fibers;
a visible-light receiver provided in the main-body case to receive the visible-light signal from a first end of the optical-fiber assembly and then convert the visible-light signal into an electric signal;
a visible-light transmitter provided in the main-body case to convert the electric signal into the visible-light signal and then transmit the visible-light signal to the first end of the optical-fiber assembly;
a first control unit performing control to send the electric signal converted by the visible-light receiver to an outside and to convert the electric signal, sent from the outside, into the visible-light signal by the visible-light transmitter;
a power unit supplying actuating power to the visible-light receiver, the visible-light transmitter, and the first control unit; and
a weight unit coupled to a lower portion of the main-body case to cause the main-body case to rest on a seabed.

2. The underwater visible light transceiving terminal of claim 1, further comprising:
a condensing lens provided between the visible-light receiver and the frame for holding the optical fibers, the visible-light transmitter being arranged to surround the visible-light receiver.

3. The underwater visible light transceiving terminal of claim 1, further comprising:
a buoyant material connected to the main-body case; and
a releasing unit positioned between the main-body case and the weight unit to release connection between the main-body case and the weight unit,
wherein, if the power of the power unit becomes equal to or less than a reference value, the first control unit actuates the releasing unit to separate the weight unit from the main-body case, and, if the weight unit is separated from the main-body case, the main-body case floats to a surface of water by buoyancy of the buoyant material.

4. The underwater visible light transceiving terminal of claim 3, wherein the buoyant material is provided with a GPS receiver to detect a location, and a location data transmitter to send location data, detected by and input from the GPS receiver, to the outside.
